(19) United States
(12) Patent Application Publication
(10) Pub. No.: US 2018/0350271 A1
(43) Pub. Date: Dec. 6, 2018

(54) System and Method for Label Construction for Ablative Laser Marking

(71) Applicant: Brady Worldwide, Inc., Milwaukee, WI (US)

(72) Inventors: Andrew Schmitt, Milwaukee, WI (US); Michael LaBelle, Hubertus, WI (US); Adam Welander, Brown Deer, WI (US)

(21) Appl. No.: 15/995,669

(22) Filed: Jun. 1, 2018

Related U.S. Application Data
(60) Provisional application No. 62/513,545, filed on Jun. 1, 2017.

(51) Int. Cl. G09F 3/00; B41M 5/24; B41M 5/41

(52) U.S. Cl. CPC G09F 3/00; B41M 5/41; B41M 5/24

(57) ABSTRACT

A label comprising multiple layers. In one aspect, the label includes an ablation layer and a print layer configured to be below the ablation layer. The ablation layer may have a first color and can comprise at least one infrared (IR) absorbing material and at least one visible light reflecting material. The print layer may have a second color and can comprise at least one IR reflecting and visible light absorbing material. The second color is darker than the first color. The unique chemical composition of the label allows for an ablative substrate with a white top layer and a black bottom layer that results in a strong contrast. In some forms, an adhesive layer in a label might serve as both the print layer and an adhesive layer. In some forms the label can be cut to size with the same laser that engraves print and graphics.

### CROSS-REFERENCE TO RELATED APPLICATIONS

This application claims the benefit of U.S. Provisional Application No. 62/513,545 entitled “System and Method for Label Construction for Ablative Laser Marking” and filed Jun. 1, 2017. The contents of that application are hereby incorporated by reference for all purposes as if set forth in their entirety herein.

### FIELD OF INVENTION

This disclosure relates to systems and methods for marking a surface, for example a surface of a label, using laser ablation.

### BACKGROUND

Laser marking is the direct marking of a surface using coherent monochromatic light. Typical lasers used for this process include near IR diode lasers or Nd:YAG systems or mid-IR CO₂ continuous wave (CW) lasers. Near IR systems are often pulsed to create time-limited bursts of energy that are hard to dissipate as heat and result in sub-surface foaming, intrinsic color change through redox reactions, or ablation. For the higher wavelength CO₂ laser systems, intrinsic marking is much more difficult due to inability to pulse the light. They are, however, typically cheaper and more powerful and can offer additional functionality like the ability to cut in addition to marking.

Cutting some types of polymeric materials used in typical self-adhesive label constructions is much easier than others. This will generally depend on the properties of polymers involved. For instance, it is well-known that polyimide films do not cut well using CO₂ lasers. The film edges tend to char and will not cut cleanly.

Another element effecting laser marking systems is that laser ablation to produce permanent marks is a subtractive printing technique. Other techniques such as Thermal Heat Transfer (THT) printing are additive. This results in most THT labels designed to have black print on a white background. Currently, laser ablated labels typically have a black background with white markings. This results in poor contrast, and is a design limitation for laser ablation systems. The order of color on the film in these cases is attributed to both light absorption and hide.

Light absorption is a material characteristic that is typically associated with a pigment's color. Darker pigments like carbon black fully absorb visible and IR light and will strongly interact with IR laser marking systems. White pigments like TiO₂ fully reflect visible and most IR light and will weakly interact with IR lasers. This is a primary reason why the state of the art is black backgrounds with laser marking products.

Hide is a print concept that defines a coating or film's ability to mask underlying layers of color. Black pigments, based on their strongly absorbing properties, are great at hiding and masking underlying layers. White pigments, based on reflective properties, are significantly less effective and require thicker coatings and higher densities to cover. To minimize product cost, it is desirable to configure black layers to reside on top of less dark layers during printing.

For print technologies like thermal heat transfer (THT) printing, when color is added to the surface, it requires less pigmentation to print a dark mark on top of a white substrate. This is an additive printing technique. For laser engraving, color is subtracted when the black layer is ablated to reveal the white. This results in a white mark revealed during ablation on a background of black.

In general, labels printed using laser ablation are more stable than traditional THT methods. Because laser materials use subtractive printing, the printed layers can be crosslinked to produce the most permanent identification for a coated product. Crosslinking allows the label to be more chemical, abrasion, and temperature resistant than typical THT labels. IR lasers also offer higher resolution, which is only limited by the beam quality and focal optics of the laser system employed.

In many cases where space is limited, smaller labels and higher print resolutions may have value. Currently, some harsh manufacturing processes preclude the use of traditional THT printing. For example, THT label compositions cannot survive high temperature reflow steps for Surface Mount Technology (SMT), wave soldering for through hole assemblies, and washing steps. Manufacturers may wish to more fully automate their labeling jobs along with their pick and place surface-mount technologies. In all of these cases, laser-marked labels offer great performance benefits, but the styles and color combinations available for durable ablative processes are currently limited.

### SUMMARY

The present disclosure addresses the aforementioned drawbacks by providing a method for manufacturing a label suitable for laser ablation. The laser ablated label presented in the present disclosure is capable of achieving black printing on a white background. The label offers high contrast, chemical durability, and resolution that is amenable for printed circuit board, electronic components, and similar labeling applications.

Some aspects of the disclosure provide a label. The label includes an ablation layer that has a first color and comprises at least one infrared (IR) absorbing material and at least one visible light reflecting material. The label further includes a substrate, such as a print layer, configured to be below the ablation layer. The substrate has a second color, and may include a print layer comprising at least one IR reflecting and visible light absorbing material. The second color of the print layer is darker than the first color of the ablation layer.

Other aspects of the disclosure provide a method for ablating a label that has an ablation layer and a print layer configured to be below the ablation layer. The ablation layer has a first color and at least one IR absorbing material. The print layer has a second color and at least one IR reflecting material. The method comprises irradiating at least one target region on the ablation layer with a laser beam. The ablation layer is irradiated until the at least one target region is removed to expose the print layer. The print layer has a second color that is darker than the first color of the ablation layer.

Some aspects of the present disclosure provide a label. The label includes an ablation layer that has a first color and comprises at least one infrared (IR) absorbing material and at least one visible light reflecting material. The label further includes a substrate, such as an adhesive layer, configured to be below the ablation layer. The substrate may include an adhesive layer comprising a polymeric material doped with at least one IR reflecting material. The second color of the print layer is darker than the first color of the ablation layer.

These and still other advantages of the invention will be apparent from the detailed description and drawings. What follows is merely a description of some preferred embodiments of the present invention. To assess the full scope of the invention the claims should be looked to as these preferred embodiments are not intended to be the only embodiments within the scope of the claims.

### DESCRIPTION OF THE DRAWINGS

FIG. 1 is a perspective view of an exemplary label that comprises a print layer and an ablation layer.

FIG. 2 is a perspective view of the label of FIG. 1 after ablation.

FIG. 3 illustrates a method of ablating a label.

FIG. 4 is a perspective view of the ablated label similar to the label of FIG. 2 further coupled to a surface of a substrate.

FIG. 5 is a perspective view of a label that comprises a film layer positioned between a print layer and an ablation layer.

FIG. 6 is a perspective view of the label of FIG. 5 with an ablated portion.

FIG. 7 is a perspective view of a label that comprises a film layer positioned between an adhesive layer and an ablation layer.

FIG. 8 is a perspective view of the label of FIG. 7 after ablation.

FIG. 9 is a perspective view of a label in which the film layer is a polyether ether ketone (PEEK) film.

FIG. 10 is a non-limiting example of a label constructed using a 980 nm NIR laser marking system at 10 W.

FIG. 11 is a non-limiting example of a label comprising 2% of an IR absorbing material constructed using a CO₂ laser at 10 um.

FIG. 12 is a non-limiting example of a label comprising 0.2% of an IR absorbing material constructed using a CO₂ laser at 10 um.

FIG. 13 is a non-limiting example of a label comprising 0.1% of an IR absorbing material constructed using a CO₂ laser at 10 um.

FIG. 14 shows a label comprising a polyimide film layer.

FIG. 15 shows a label comprising a polyimide film taken with a compound light microscope in dark field mode.

FIG. 16 shows a label comprising a polyether ether ketone film.

FIG. 17 is a non-limiting example of an ablated label that comprises a polyether ether ketone film.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

The present disclosure relates to a method for manufacturing an ablated label with dark markings and a white background. As will be described below, this removes the need to use carbonization or expensive wavelength-specific intrinsic laser marking pigments and results in an extremely durable construction suitable for the electronics, automotive, and general industrial markets.

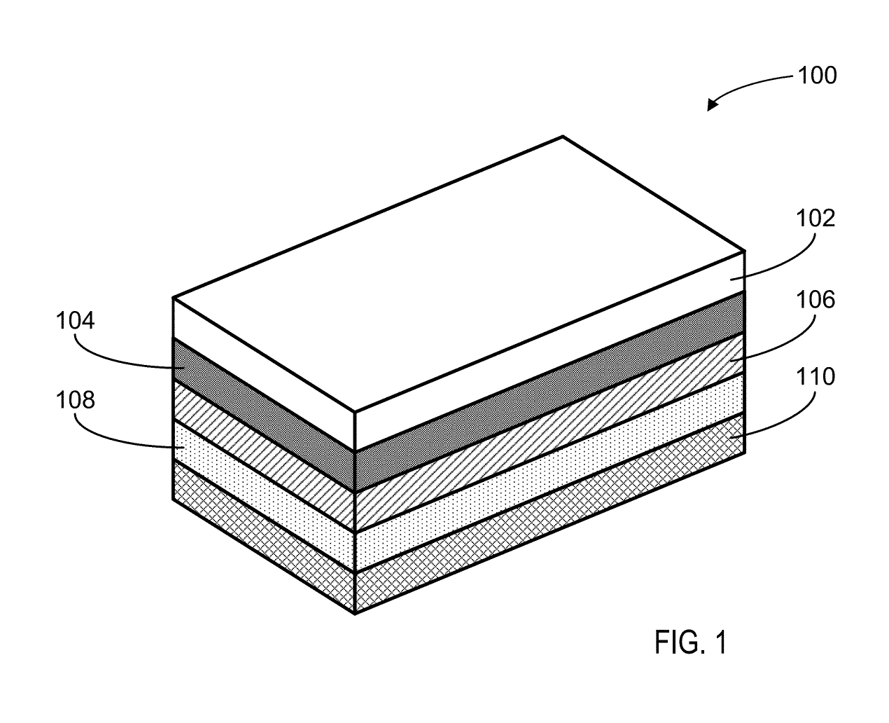

FIG. 1 shows a label 100 according to one embodiment of the present disclosure. In the illustrated embodiment, the label 100 includes an ablation layer 102 in contact with a substrate, such as a print layer 104. A film layer 106 is arranged between the print layer 104 and an adhesive layer 108 and maintains contact with each layer, respectively. The label 100 further includes a removable liner 110 that protects the adhesive layer 108 prior to application of the label 100 to a target.

Laser ablation is a subtractive process, and therefore the ablation layer 102 provides a background color for the label 100. In some embodiments, the ablation layer 102 comprises a polymeric material, at least one infrared (IR) absorbing material, and at least one visible light reflecting material. The visible light reflecting material may be added to the ablation layer 102 to provide a first color, a gloss, or other visual effects for the label 100. In some embodiments, the first color comprises a light pigment, while in other embodiments the first color is substantially white. In other embodiments, the color of the ablation layer 102 is white. Suitable visible light reflecting materials may include metal oxides. In one non-limiting example, the metal oxide comprises titanium dioxide (TiO₂).

One of the challenges associated with achieving a substantially white ablation layer 102 is that metal oxides, such as TiO₂, typically weakly interact with IR lasers and are therefore difficult to ablate. To account for this deficiency, IR absorbing materials may be doped into the ablation layer 102 to increase the energy transfer from the laser beam to the ablation layer 102. Suitable IR absorbing materials may include carbon black, or any common grade of standard dark pigments. In some embodiments, polymeric materials may be added to the ablation layer 102 to provide support and durability for the layer. Suitable polymeric materials may include aliphatic polyurethanes, aromatic polyurethanes, polyesters, polyacrylates, crosslinked phenoxy resins, and mixtures thereof. In other embodiments, the polymeric material may absorb IR irradiation. In such a case, additional dopants such as carbon black may not be needed, but may be added to increase the ablation efficiency and to allow the laser system to operate at lower powers.

In some embodiments, the print layer 104 provides markings that are visible after a portion of the ablation layer 102 has been removed by a laser. The print layer 104 comprises materials that reflect IR irradiation rather than absorbing it into the material. This prevents energy absorption and heat generation that can result in the ablation of the material of the print layer 104. In some aspects, the print layer 104 comprises at least one IR reflecting and visible light absorbing material. The visible light absorbing material may provide the print layer 104 with a second color. In some embodiments, the second color comprises a dark pigment, while in other embodiments the second color is substantially black. In other embodiments, the color of the print layer 104 is black.

Suitable IR reflective pigments may include mixed metal oxides (MMO), which are sometimes referred to as complex inorganic colored pigments (CICP) that provide lasting color in demanding exterior applications. The inorganic crystalline nature of these pigments yields properties similar to thermoelectric materials where electronically the structures can very effectively absorb visible light to appear colored. Vibrationally, the structures are less active than typical colored pigments and reflect much of the IR light from the sun. This physical property of these materials is leveraged here in compositions for use with IR laser systems.

In some embodiments, the MMO may comprise chrome oxide green, chromium iron oxide, sodium aluminum sulphursilicate, manganese antimony oxide, chrome antimony tin oxide, cobalt aluminate, cobalt chromite, iron ammonium ferrocyanide, cobalt titanate, chrome iron nickel oxide, nickel antimony titanate, zinc iron chromite, iron oxide, zinc iron chromite, bismuth vanadate, iron manganese oxide, and mixtures thereof. Doping a material with traditional dark pigments like carbon black results in laser-active materials that will ablate in the presence of the laser beam. However, in some embodiments, small quantities of dark pigments like carbon black may be added to the print layer 104 to provide the second color, while still maintaining resistance to ablation. This process is known as color matching.

In some embodiments, the film layer 106 provides support and resistance against shrinking, stretching, bending, and tearing. In some embodiments, the film layer 106 comprises a polymeric resin. Suitable polymeric resins may include polyester, polyimide, polypropylene, polyether ether ketone, and combinations thereof. In some embodiments, the film layer 106 is substantially translucent, while in other embodiments the film layer 106 is optically clear.

The adhesive layer 108 allows the label 100 to attach to the target. In some embodiments the adhesive layer 108 comprises a pressure-sensitive adhesive (PSA). Suitable PSAs may include elastomers doped with a tackifier. In some aspects, the elastomer may include acrylics, butyl rubber, ethylene-vinyl acetate, natural rubber, nitriles, silicon rubbers, and mixtures thereof. In some aspects, the tackifier could include silicate resins comprising trimethyl silane and silicon tetrachloride. In some embodiments, the liner 110 includes a releasable layer that protects the adhesive layer 108 prior to application of the label 100. In some embodiments, the liner 110 comprises a silicone coated paper, a clay coated paper, polyesters, and mixtures thereof.

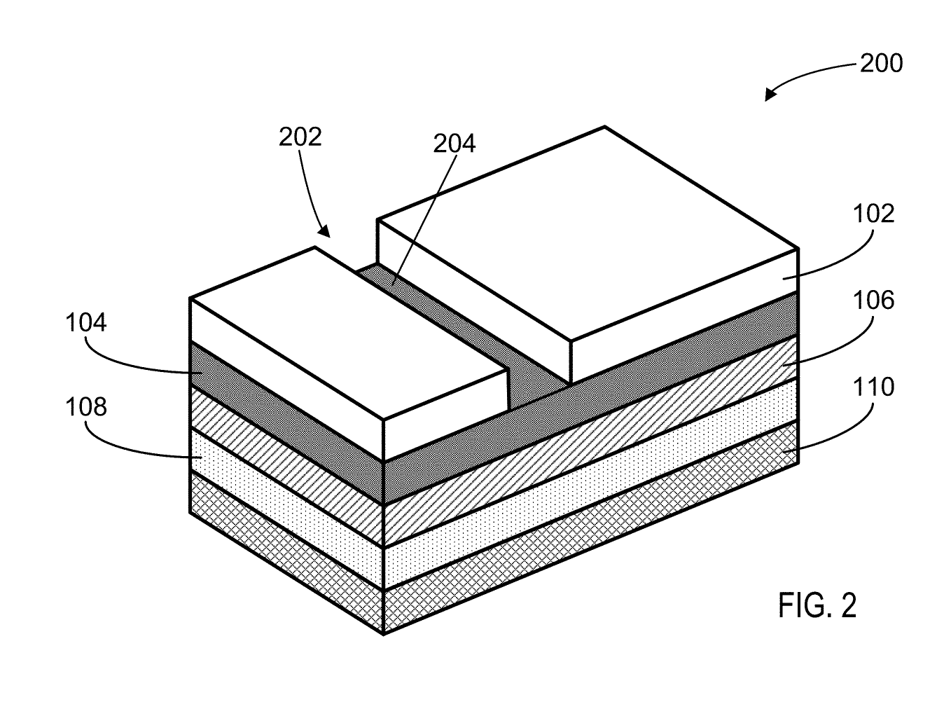

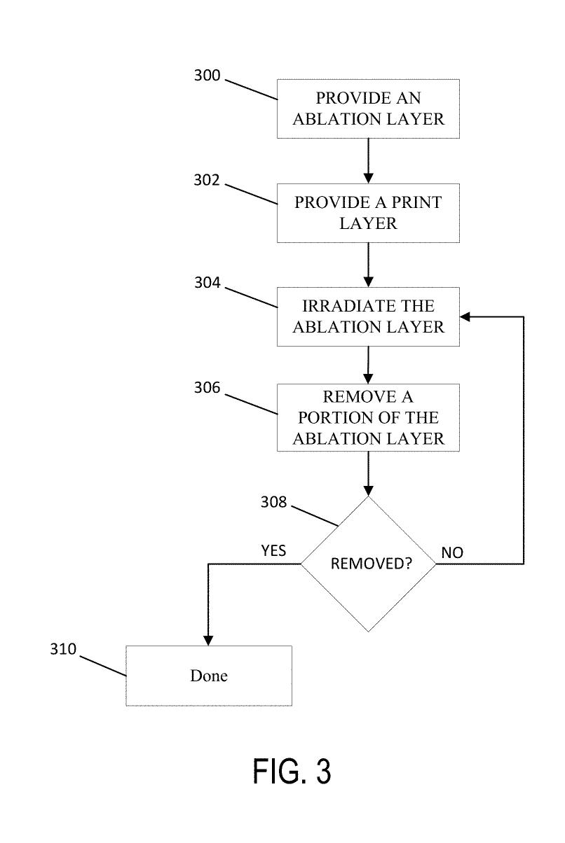

FIG. 2 shows a non-limiting example of an ablated label 200 (which is simply the label 100 after ablation) and FIG. 3 sets forth the steps for forming the ablated label 200 from the precursor label 100. As indicated by steps 300-302, a label 100 is provided that includes both an ablation layer 102 and a substrate, such as a print layer 104 having, for example, the structure of FIG. 1. In some aspects, the ablation layer 102 may be marked with indicia to outline a target region 202 prior to irradiation. A laser beam is then directed to irradiate the target region 202 to remove a portion of the ablation layer 102, as indicated by steps 304-306. The laser beam will continue to irradiate the target region 202 until a top surface 204 of the print layer 104 is exposed, as indicated by decision block 308. Once the top surface 204 is exposed within the target region 202, the process completes 310 and an ablated label 200 is formed from the precursor label 100.

In some embodiments, the laser beam is produced from a laser system. Suitable laser systems include near IR diode lasers, Nd—YAG lasers, or CO₂ lasers. In some embodiments, the laser beam may be pulsed to create a time-limited burst of energy to the target region 202. It is contemplated that the laser beam may have a wavelength between 800 nm and 15 μm in some forms, working particularly well over a wide range of infrared frequencies. In contrast, ultraviolet frequencies may work less well or not at all, as complex oxides only reflect hot colors (i.e., IR frequencies). Further, it is contemplated that the laser system may operate at a power level between 1 W and 40 W with the power employed being strongly correlated to the raster speed of the beam. In some exemplary forms, the laser system may cut the ablation layer 102 at a speed between 100 mm/s and 10000 mm/s with the proviso that faster speeds may employ higher laser powers as is known by those skilled in the art. These various parameters are provided as being exemplary, but other workable operational laser parameters are likely.

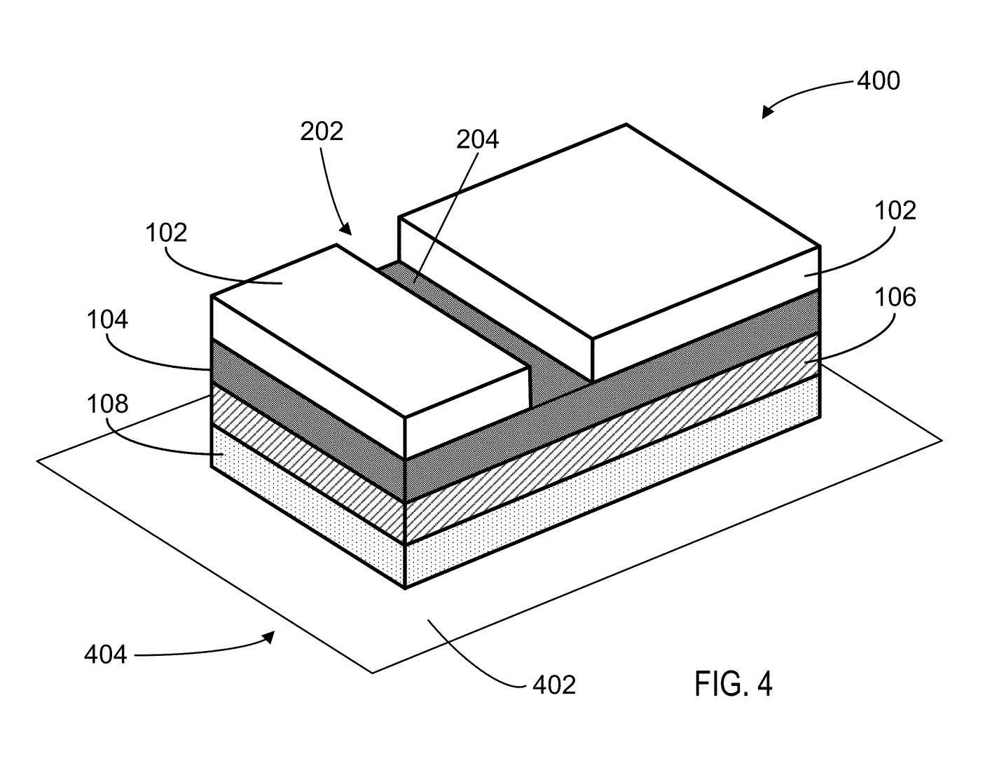

FIG. 4 shows one non-limiting example application of a label 400, which is effectively the label 100 after ablation, having its liner 110 removed, and being adhesively attached to a surface 402 of a target material 404. The surface 402 is illustrated as flat and smooth, but this is not required. The surface 402 may be curved, irregularly textured, undulating, or may be of other shapes. In some aspects, suitable target materials 404 may include electronics, such as printed circuit boards and electronic components. Other non-limiting examples include substrates from the automotive and general industrial markets. These substrates are often subjected to high performance environments that require durable, reliable, and compliant labelling solutions that can withstand the processing conditions used to clean, decontaminate, and connect each component.

Because laser ablation processes are subtractive, and not additive, the layers within the label may be chemically crosslinked to provide improved durability over additive methods. Additionally, laser etching provides higher resolution over additive processes. Labels that include higher resolution and durability can offer a myriad of benefits to manufacturing facilities such as reduction in returns and errors, production cost savings, reduced warranty liabilities, and seamless compliance with trade and substance regulations.

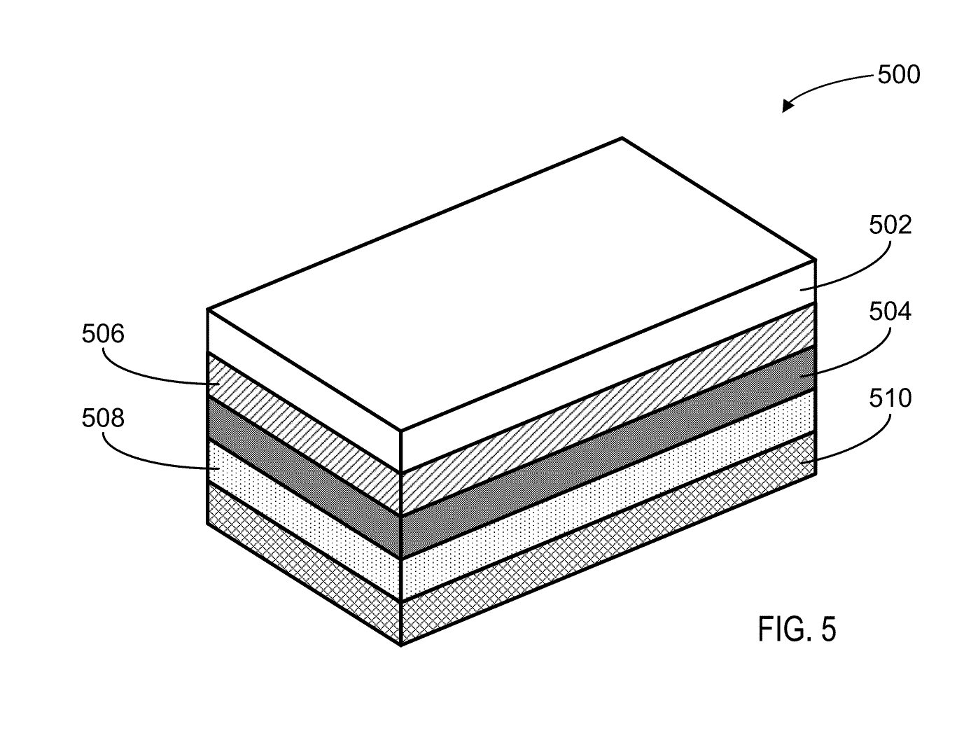

FIG. 5 shows a label 500 with an alternative structure in which an ablation layer 502 in contact with a film layer 506. A print layer 504 is arranged between the film layer 506 and an adhesive layer 508 and maintains contact with each layer, respectively. The label 500 further includes a removable liner 510 that protects the adhesive layer 508 prior to application of the label 500 to a target. Each of the layers may comprise similar compositions as presented above.

In this non-limiting example, the print layer 504 resides beneath both the ablation layer 502 and the film layer 506. In some aspects, separating the layers protects the print layer 504 from highly powered laser systems that may be too powerful to be fully reflected. In this embodiment, the film layer 506 is substantially translucent or optically clear so that the print layer 504 may be viewed from above or through the film layer 506. In some aspects, the film layer 506 may comprise polyimide which is colored but translucent. In such a case, the print layer 504 can still achieve a dark contrasting mark, but will slightly impact color due to the polyimide's inherent yellow hue.

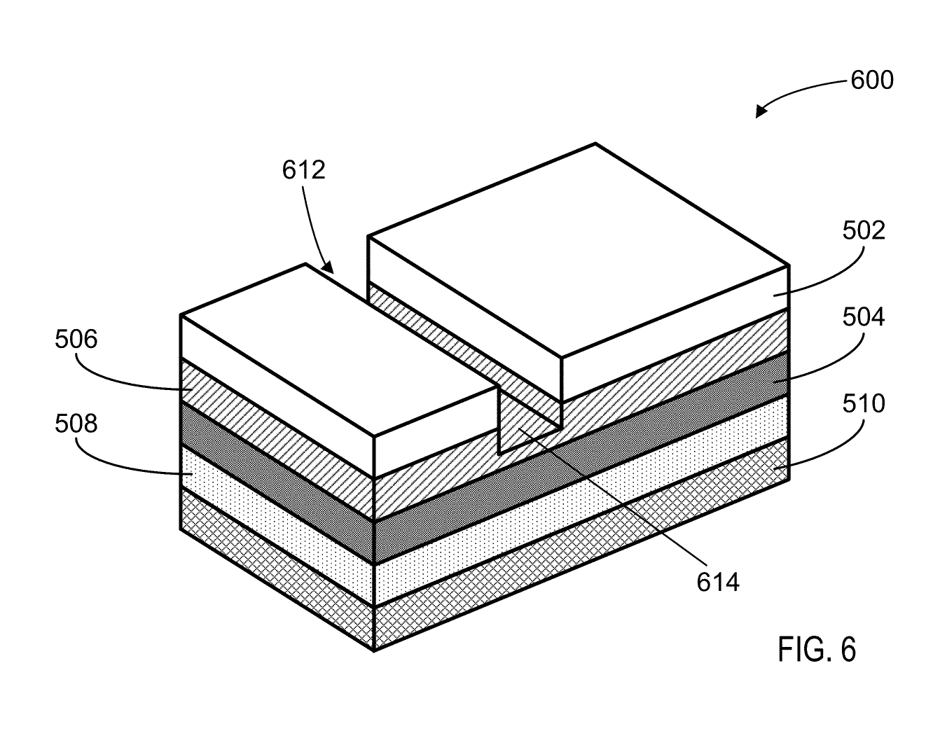

FIG. 6 shows a non-limiting example of an ablated label 600 which is effectively label 500 after ablation. The label 600 includes a target region 612 that has been removed by irradiation from a laser system. As described above, the laser beam will interact with the IR absorbers in the ablation layer 502 to selectively etch, engrave, or mark in the target region 612 determined by the marking indicia to be written. The laser will etch the top layer quickly due to strong energy transfer from the laser beam to the ablation layer 502 due to the IR absorbers. Once the ablation layer 502 is removed, the laser beam may slightly interact with the film layer 506 due to slight IR absorptivity present in the layer. However, much of the light will pass through the film layer 506, which may be clear or substantially translucent, and reflect off the reflective print layer 508 below stopping or slowing greatly the etching rate in this layer and leaving the dark layer exposed to the top for viewing. In some embodiments, the ablated target region 612 extends longitudinally to a top surface 614 of the film layer 506. In some aspects, the ablated target region 612 extends at least partially into the film layer 506. In other aspects, the ablated target region 612 extends all the way through the film layer 506.

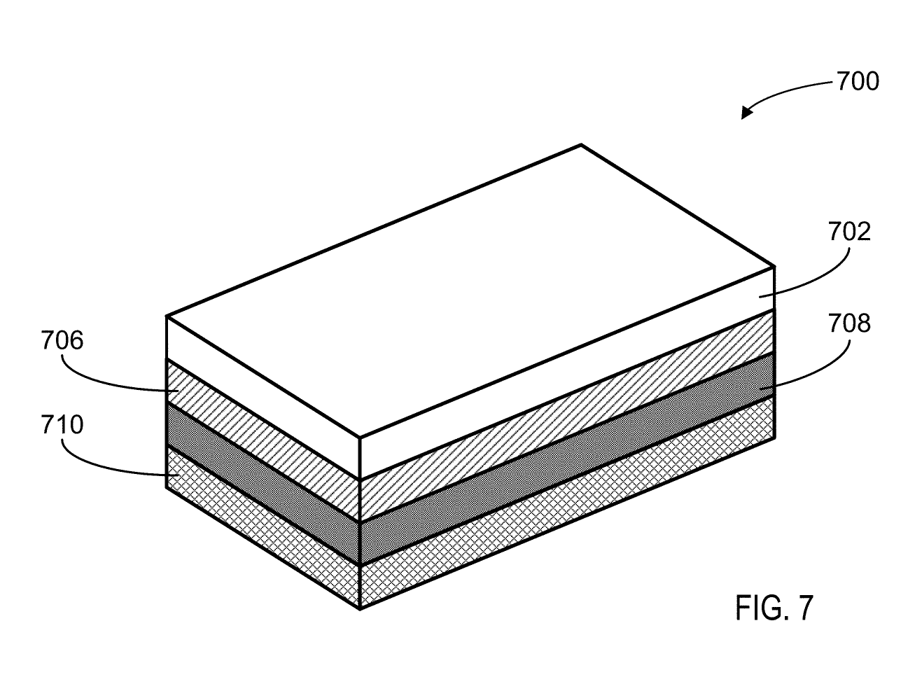

FIG. 7 shows a label 700 with yet another alternative structure. The label 700 includes an ablation layer 702 in contact with a substrate, such as a film layer 706. An adhesive layer 708 is arranged between the film layer 706 and a removable liner 710 and maintains contact with each layer, respectively. The removable liner 710 protects the adhesive layer 708 prior to application of the label 700 to a target. In this embodiment, the adhesive layer 708 may comprise any polymeric resin as described above, and may also further comprise any IR reflecting material and visible light absorbing material as described above, effectively turning it into a dual adhesive/print layer. The other layers in this embodiment may comprise similar compositions as presented above.

Separating the layers protects the adhesive layer 708 from highly powered laser systems that may be too powerful to be fully reflected. In this embodiment, the film layer 706 is substantially translucent or optically clear so that the adhesive layer 708 (which doubles as a print layer) may be viewed from above. As a second advantage to label 700, the IR reflective material is doped into the adhesive layer 708. This simplifies the construction to fewer layers reducing the manufacturing costs.

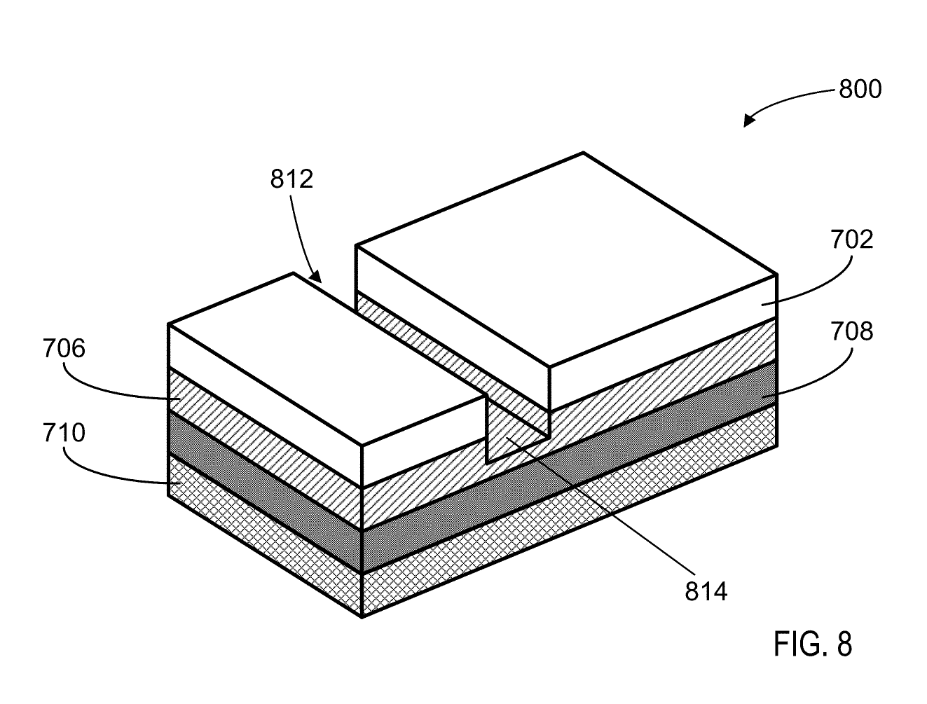

FIG. 8 shows an ablated label 800, which is effectively an ablated form of label 700, in which a target region 812 has been removed by irradiation from a laser system. As described above, the laser beam will interact with the IR absorbers in the ablation layer 702 to selectively etch, engrave, or mark in the target region 812 determined by the marking indicia to be written. The laser beam will etch the top layer quickly due to strong energy transfer from the laser beam to the ablation layer 502 due to the IR absorbing materials. Once the ablation layer 702 is removed, the laser beam may slightly interact with the film layer 706 due to slight IR absorptivity present in the layer. However, much of the light will pass through the film layer 706, which may be clear or substantially translucent, and reflect off the adhesive layer 708 below stopping or slowing greatly the etching rate in this layer and leaving the dark layer exposed to the top for viewing. In some embodiments, the ablated target region 812 extends longitudinally to a top surface 814 of the film layer 706. In some aspects, the ablated target region 812 extends at least partially into the film layer 706. In other aspects, the ablated target region 812 extends all the way through the film layer 706.

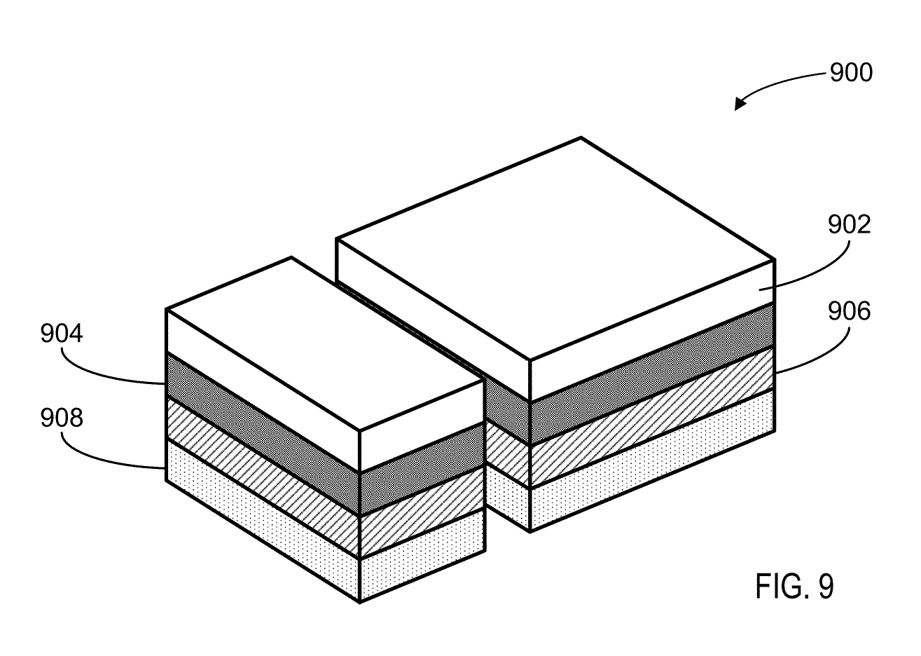

One of the challenges of providing a durable laser-markable label is that the physical, chemical, and crystalline properties of the film layer may be difficult to cut with IR laser systems as is the case for polyimides and may result in crumbling and generation of debris. This is an undesirable trait for electronic industries where debris can negatively impact product performance. Accordingly, FIG. 9 shows yet another label 900 in which the film layer has been modified to be a different material such that all of the layers of the label structure may be removed with a laser including an ablation layer 902, a print layer 904, a film layer 906 which is laser-cuttable, and an adhesive layer 908 and excepting a releasable liner layer (not shown in FIG. 9). The film layer 906 may preferably be a polyether ether ketone film layer, but it could be another cuttable film such as, for example, polyethylene (PE), polypropylene (PP), or polyethylene phtherathalate (PET). It is further contemplated that, in some forms, the ablation layer 902 and/or the print layer 904 may be omitted from this structure if the film layer is cuttable. A PEEK film layer permits the label to withstand high temperatures associated with, for example, solder reflow and harsh chemicals used to clean and prepare parts for substrates. Any of the preceding labels 100, 500, 700 could incorporate the PEEK film layer or cuttable film layers prior to ablation. Thus, the particular layer structure of label 900 is provided by way of example only.

### Examples

The following examples set forth, in detail, ways in which any of the labels 100-200 and 400-800 may be used or implemented, and assist to enable one of skill in the art to more readily understand the principles thereof. The following examples are presented by way of illustration and are not meant to be limiting in any way.

Example compositions for the layers in the labels of the present disclosure are given in the following table:

TABLE 1
Example ablation layer compositions and
performance using different laser systems

| Ablation layer | Example 4 | Example 5 | Example 6 | Example 7 |
|---|---|---|---|---|
| Actega process black UV | 98% | 99.80% | 99.90% | 100% |
| acrylic coating | | | | |
| Actega process white UV | 2% | 0.20% | 0.10% | 0% |
| acrylic coating | | | | |
| Printable using 10 W | yes | no | no | no |
| (MAX) near-IR laser | | | | |
| Printable using 40 W | yes | yes | yes | yes |
| (MAX) CO₂ laser | | | | |

TABLE 2
Example adhesive layer compositions

| Adhesive layer | Example P1 | Example P2 |
|---|---|---|
| Loctite Duro-Tak 230A | 95% | 97.50% |
| V-760 chromium iron oxide | 5% | 2.50% |

TABLE 3
Example print layer compositions

| Print layer | Example P3 |
|---|---|
| Adcote 1217-D | 79% |
| 1,3-dioxolane | 14% |
| V-760 chromium iron oxide | 5% |
| toluene diisocyanate | 2% |

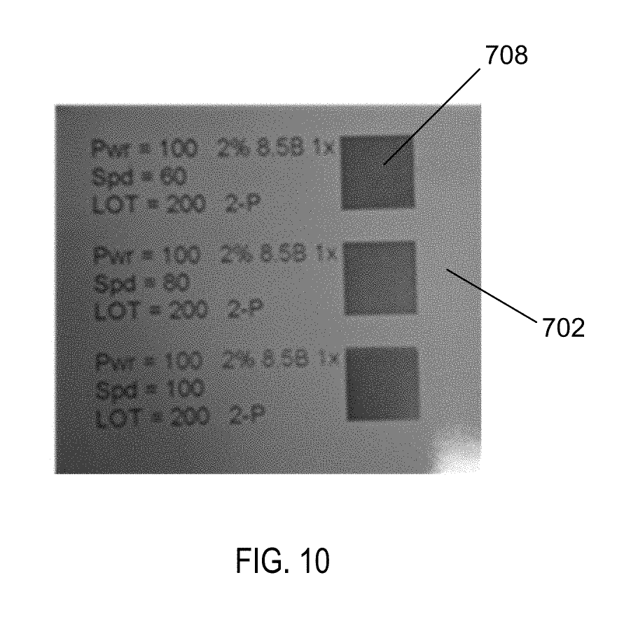

FIG. 10 shows a laser ablated label using a configuration similar to FIG. 8. The label includes an ablation layer 702 that comprises the compositions in Example 4, and an adhesive layer 708 that comprises the compositions in Example P1. In this case, the IR reflective material was embedded into the adhesive layer 708. The film layer 706 included a translucent polyimide film where the black layer is dark enough to provide contrast when the top ablation layer 702 is removed via exposure to the near IR laser. The IR absorbing pigment in the top ablation layer is loaded at a high level (2%) reducing somewhat the maximum contrast achievable. Ablation was performed using a 980 nm near IR laser marking system at 10 W.

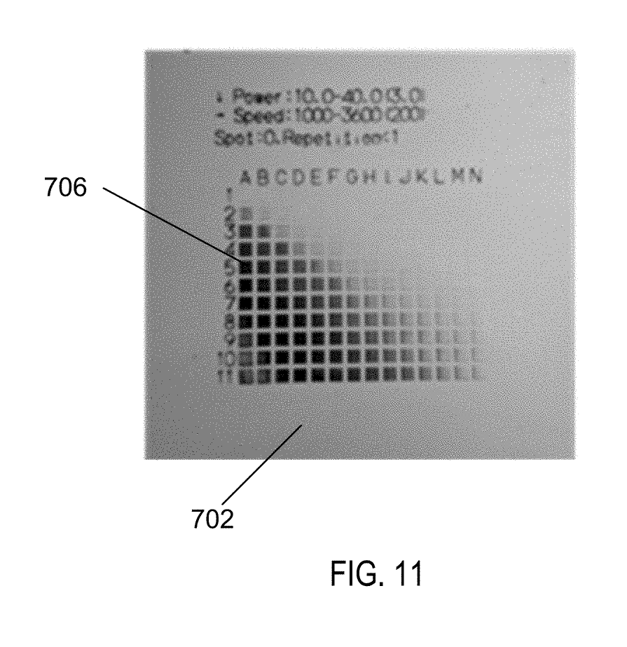

FIG. 11 shows the ablation results for a laser ablated label using a configuration similar to FIG. 8. The label includes an ablation layer 702 that comprises the composition in Example 5, and an adhesive layer 708 that comprises the compositions in Example P1. Ablation was performed using a CO₂ laser at 10 um. Using less (0.2%) of the IR absorbing material requires the use of higher power laser systems to ablate through the ablation layer 702. This results in much higher contrast between the background ablation layer 702 and the adhesive layer 708. This array shows the effect of power (1-11 increasing power) and write speed (A-N increasing speed). At low speeds (A, B) and high powers (9-11) the laser beam can damage the adhesive layer 708. Power and speed arrays like this can be used to quickly find the best operating window for a given laser system and label construction combination. With the IR reflective layer a wide window exists to mark or engrave this label with good contrast and fast speeds.

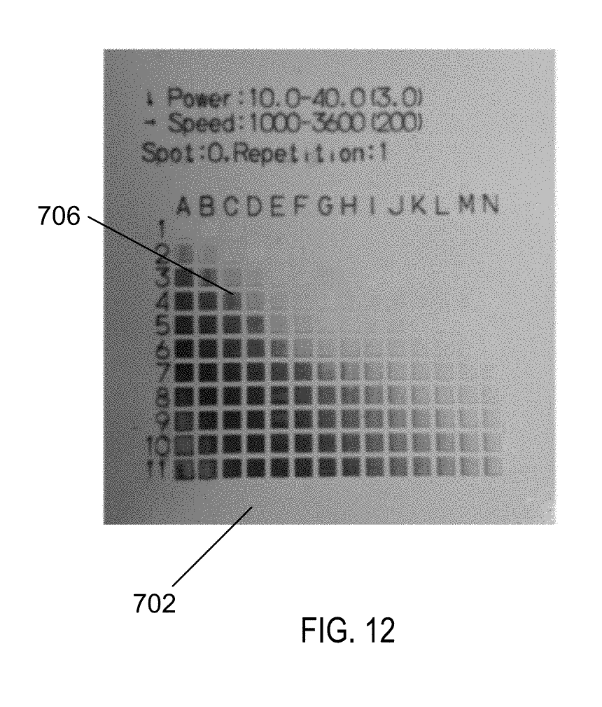

FIG. 12 shows the ablation results for a laser ablated label using a configuration similar to FIG. 8. The label includes an ablation layer 702 that comprises the composition in Example 6, and an adhesive layer 708 that comprises the compositions in Example P2. Ablation was performed using a CO₂ laser at 10 um. Using even less (0.1%) of the IR absorbing material requires a larger combination of high powers and slower speeds to write. This results in a slightly smaller processing window for marking and engraving, but results in better contrast at optimal settings due to the whiter background color of the ablation layer.

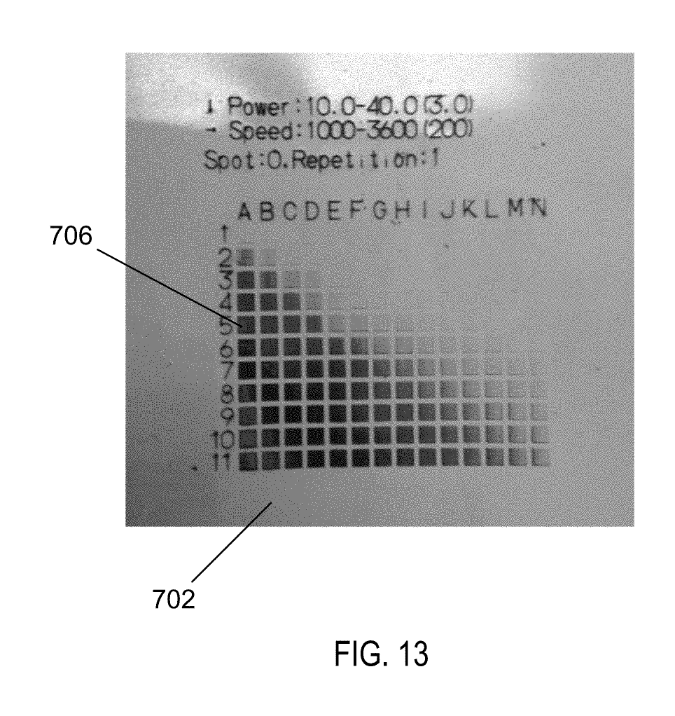

FIG. 13 shows the ablation results for a laser ablated label using a configuration similar to FIG. 8. The label includes an ablation layer 702 that comprises the composition in Example 7, and an adhesive layer 708 that comprises the compositions in Example P2. Ablation was performed using a CO₂ laser at 10 um. Using only the intrinsic IR absorbing power of the polymeric resin in the ablation layer 702 pushes the processing window further to the bottom left of the array requiring slower speeds and high powers. An advantage of the adhesive layer 708 is shown here. Even when using the highest laser settings there is still an operating window to which the ablation layer is removed and the IR reflective dark adhesive layer 708 is unaffected. This provides the maximum achievable contrast between the light ablation layer and the dark print layer.

Typical labels for use in traceability and identification of printed circuit boards consist of top-coated polyimide films based on the need to withstand high temperatures associated with solder reflow and harsh chemicals used to clean and prepare the parts. Laser marking technology has offered manufacturers not only the ability to mark boards but to also cut labels to size. Unfortunately the physical, chemical, and crystalline properties of polyimide make it exceptionally difficult to cut with IR lasers.

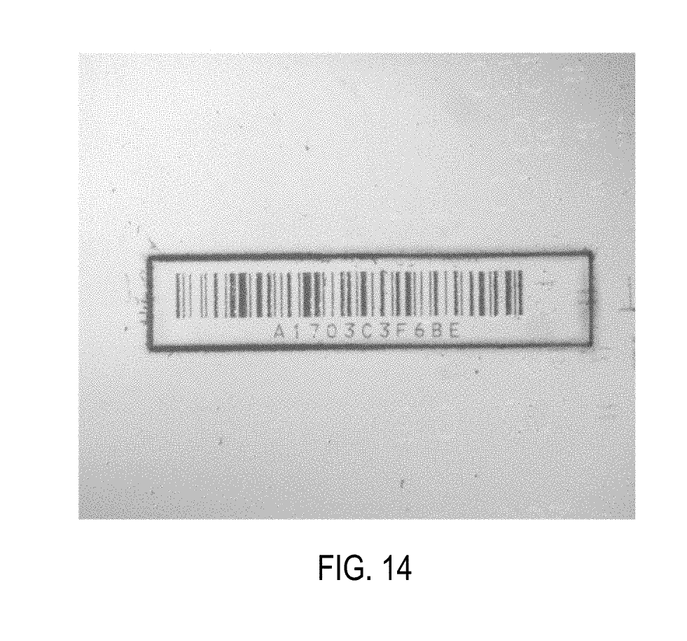

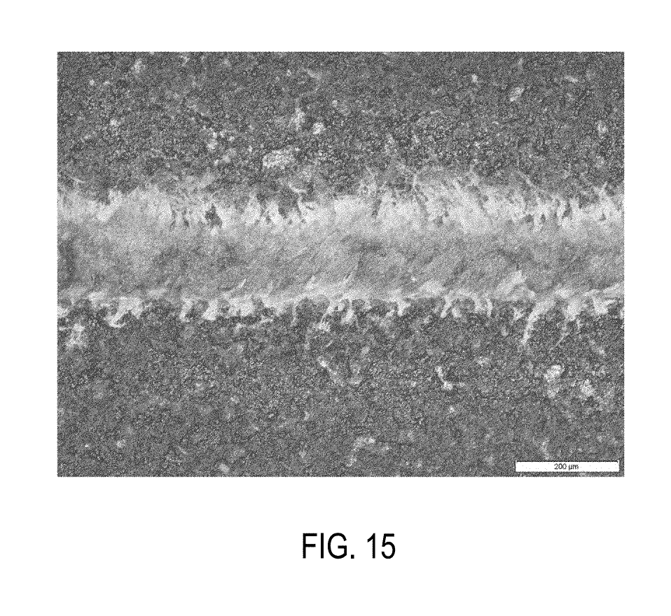

FIG. 14 shows the results of cutting and ablating a label consistent with the present disclosure that includes a polyimide top layer. FIG. 15 shows a close-up view of the cut target region, which shows filaments and debris that result from the removal of the polyimide material. FIG. 15 was taken on a compound light microscope using enhanced focus imaging in dark field mode. The amount of debris is unacceptable in the electronics industry where every component is stringently cleaned and processed to reduce any defect components or potential failure modes after manufacture.

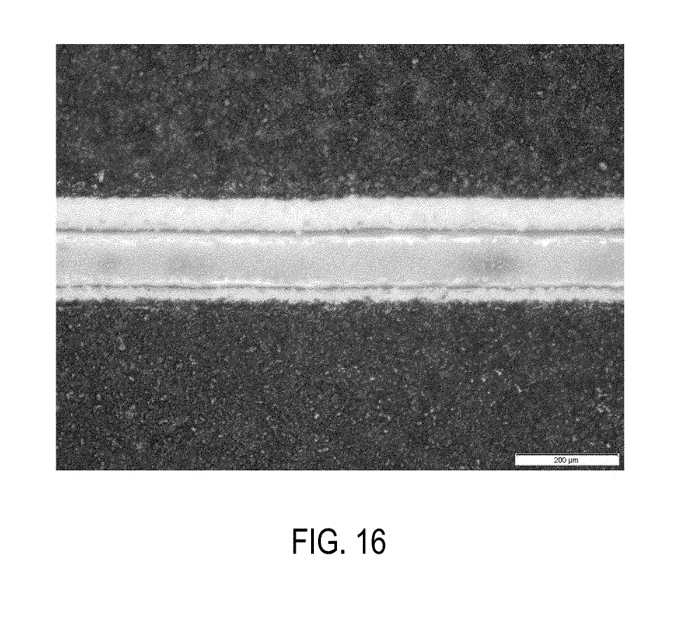

This problem was ameliorated by using another polymeric resin for the top layer. Polyether ether ketone (PEEK) allows the labels to be marked and cut with clean edges as shown in FIG. 16. Additionally, PEEK has a melt point of 343° C. and has significant chemical resistance making it an outstanding choice for electronics and PCB marking that are often exposed to 280° C. during solder reflow along with harsh aqueous washing steps. Samples were placed on FR4 (glass-filled epoxy composite with flame retardants) and exposed to typical solder reflow conditions and multiple cleaning steps and were unaffected by these conditions.

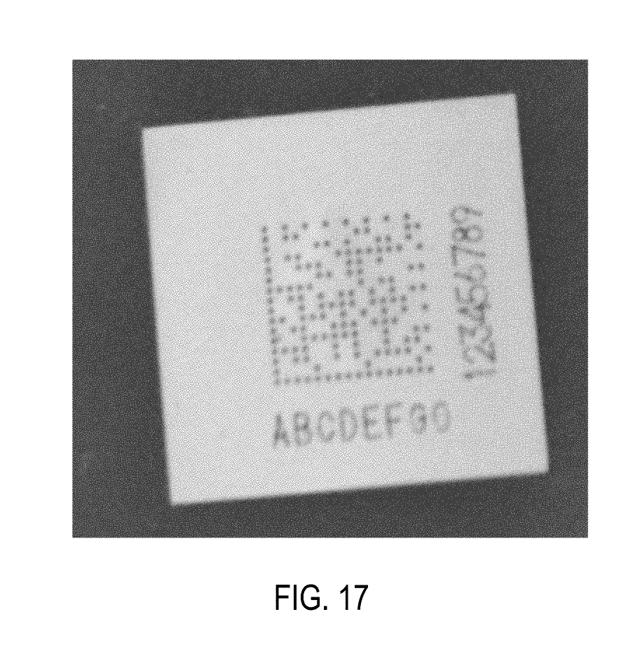

Because PEEK is a translucent film both labels were constructed using configurations similar to label 100 and label 500. Table 4 shows example compositions for the labels using PEEK as the film layer. Both labels 100 and 500 worked equally well with the PEEK polymeric resin. The contrast was generated using a CO₂ CW laser and used to print a 2D barcode, as shown in FIG. 17. This allows for arbitrary shaped labels to be cut and engraved on demand from a master roll.

This technique is compatible with typical pick and place operations used for labels and surface mount components during the board assembly process. Specific advantages of this approach include eliminating operator touch points that could generate electrostatic discharges, removing material change-overs to place various sized labels, and allowing for multi-use identification for traceability and compliance. These layers could also be combined with electrostatic dissipative layers beneath the film and in the adhesive to further mitigate any risk of damage to the board from the label or labelling process. The label in FIG. 16 was laser marked and cut using a CO₂ CW laser. The edges are clean and the contrasting mark is dark enough for the 2D bar code to be read using machine vision.

TABLE 4
Example label compositions comprising a PEEK film layer.

| Material | Formula |
|---|---|
| Layer 1: Print layer | |
| Polyester resin | 60% |
| V760 pigment | 36% |
| Isocyanate | 4% |
| Layer 2: Ablation layer | |
| Polyester resin | 55% |
| Carbon black dispersion | 1% |
| Silica Gel | 5% |
| Titanium dioxide | 35% |
| Isocyanate | 4% |

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein.

Various features and advantages of the invention are set forth in the following claims.

We claim:

1. A label comprising:
an ablation layer having a first color and comprising at least one infrared (IR) absorbing material and at least one visible light reflecting material; and
a substrate configured to be below the ablation layer, the substrate having a second color, and comprising at least one IR reflecting and visible light absorbing material;
wherein the second color is darker than the first color.

2. The label of claim 1, wherein the first color is substantially white.

3. The label of claim 1, wherein the second color is substantially black.

4. The label of claim 1, wherein the at least one IR absorbing material includes carbon black.

5. The label of claim 1, wherein the substrate is located beneath a substantially transparent film layer on the side opposite of the ablation layer.

6. The label of claim 1, wherein the at least one visible light reflecting material in the ablation layer includes a metal oxide comprising titanium dioxide (TiO₂).

7. The label of claim 1, wherein the IR reflecting and visible light absorbing material in the substrate includes a mixed metal oxide selected from the group consisting of chrome oxide green, chromium iron oxide, sodium aluminum sulphursilicate, manganese antimony oxide, chrome antimony tin oxide, cobalt aluminate, cobalt chromite, iron ammonium ferrocyanide, cobalt titanate, chrome iron nickel oxide, nickel antimony titanate, zinc iron chromite, iron oxide, zinc iron chromite, bismuth vanadate, and iron manganese oxide.

8. The label of claim 1, wherein the ablation layer and the substrate further comprises a polymeric material, wherein the polymeric material is selected from the group consisting of aliphatic polyurethanes, aromatic polyurethanes, polyesters, polyacrylates, and crosslinked phenoxy resins.

9. The label of claim 1, wherein the substrate further comprises a film layer coupled to a bottom face of the print layer in which the film layer includes a polymeric resin selected from the group consisting of polyester, polyimide, polypropylene, and polyether ether ketone.

10. The label of claim 9, wherein the substrate further comprises an adhesive layer coupled to a bottom face of the film layer.

11. The label of claim 10, wherein the adhesive layer comprises a pressure-sensitive adhesive.

12. The label of claim 10, wherein the substrate further comprises a liner coupled to the bottom face of the adhesive layer in which the liner is a releasable thin film comprising a material selected from the group consisting of silicone, clay coated papers, and polyesters.

13. The label of claim 1, wherein the substrate comprises an adhesive layer, wherein the adhesive layer includes a polymeric material doped with at least one of the IR reflecting material.

14. The label of claim 13, wherein the polymeric material comprises a pressure-sensitive adhesive.

15. A method for ablating a label having an ablation layer and a substrate configured to be below the ablation layer, the method comprising:
(a) irradiating at least one target region on the ablation layer with a laser beam; and
(b) removing the ablation layer in the at least one target region with the laser beam to expose the substrate;
wherein the ablation layer has a first color and at least one IR absorbing material, wherein the substrate has a second color and at least one IR reflecting material, and wherein the second color is darker than the first color.

16. The method of claim 15, wherein the ablation layer and the print layer are crosslinked.

17. The method of claim 15, wherein the laser beam is produced from a laser selected from the group consisting of a near IR diode laser, a Nd:YAG laser, and a CO₂ laser.

18. The method of claim 17, wherein the laser beam includes a wavelength between 800 nm and 15 μm.

19. The method of claim 17, wherein the laser operates at a maximum power level between 1 and 40 Watts.

20. The method of claim 15, wherein step (b) includes removing all the material within the at least one target region not necessarily including a liner configured on the label.
